(19) United States
(12) Patent Application Publication
(10) Pub. No.: US 2008/0115949 A1
(43) Pub. Date: May 22, 2008

(54) Method For Fire Suppression

(75) Inventors: Xianming Jimmy Li, Orefield, PA (US); Pingping Ma, Orefield, PA (US); Vincent Louis Magnotta, Allentown, PA (US); John Chao-Chiang Tao, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 11/939,823

(22) Filed: Nov. 14, 2007

Related U.S. Application Data
(60) Provisional application No. 60/860,040, filed on Nov. 20, 2006.

(51) Int. Cl. A62C 2/00

(52) U.S. Cl. 169/44; 169/46

(57) ABSTRACT

This invention is directed to an improvement in a process for producing a fire suppressing mist comprised of finely divided water droplets and a fire suppressing gas in response to fires in an enclosed area. The improvement resides in the finding that one can reduce the size of water droplets generated in a nozzle system designed for generating said fire suppressing mist at low pressure by using deionized water as the water source. The fire suppressing mist can also include a low concentration of surfactant.

### CROSS-REFERENCE TO RELATED APPLICATIONS

This Application claims the benefit of Provisional Application No. 60/860,040, filed on Nov. 20, 2006. The disclosure of that Application is hereby incorporated by reference.

### BACKGROUND OF THE INVENTION

Fires within enclosed structures not only pose a significant hazard to life but they can also cause irreparable damage to equipment. Although there have been significant strides in fire prevention, fires do remain a problem. The keys to fire control are early detection, fire containment, and fire suppression.

Fire suppression or fire extinguishing methods generally employ one or more of principles of fire control, e.g., dilution of the oxygen concentration in the surrounding air, lowering of the temperature in the combustion zone and chemical interference. Water is the most common fire suppressant, but, even though water is an environmentally friendly fire suppressant, water can cause tremendous damage to structures and equipment, particularly electrical equipment. Halogen based fire suppressants have adverse effects on humans and the environment. Carbon dioxide and nitrogen have been used as effective fire suppressants because they are oxygen diluting gases. But such gases can cause asphyxiation for occupants with few warning symptoms.

Refinements in the way water and fire suppressants are delivered in the suppression of fires have been underway for a long time. Sprinklers are one form of system for delivering water to suppress fires, but the large size of the droplets and the high flowrates from such sprinklers cause flooding and extensive damage to equipment. Recent developments have focused on the use of mists or fogs comprised of very finely divided water droplets to suppress fires. The use of finely divided droplets of water accomplishes three major objectives: 1) finely divided droplets vaporize readily and thus impact the partial pressure of ambient oxygen in the vicinity of the fire; 2) finely divided droplets reduce the chance of damage to equipment; and 3) vaporization of the droplets rapidly absorbs heat and reduces gas temperature to hinder fire propagation.

The following patents are representative of approaches to fire suppression that include safety and environmental considerations:

U.S. Pat. No. 4,807,706 discloses a method of fire suppression wherein a breathable gas is used in fire suppression. The gas is designed to suppress fires while at the same time maintain a breathable atmosphere capable of supporting life. The gas used to suppress fires includes nitrogen or helium to reduce the oxygen concentration to about 8 and 15% while increasing the carbon dioxide content to a level from 2 to 5%. The presence of a small amount of carbon dioxide helps sustain mental acuity and consciousness.

WO/93/098,848 discloses a method of fire suppression comprised of a mixture of a breathable gas and water. The patentees pointed out that water sprays in an amount from 5 to 30 ml water per square meter/minute have been used as a means of fire suppression but such sprays were found to cause damage to equipment. The fire suppression approach disclosed in '848 employs streams of water and nitrogen focused such that the streams cross resulting in atomization of the water. Optionally, carbon dioxide is included in small amounts. Inert gas is introduced in an amount of from about 10 to 50% of the volume of the room affected in order to reduce oxygen concentrations to 8 to 19%. Water is introduced in an amount from 50 to 2000 g/m³.

U.S. Pat. No. 6,390,203 discloses fire suppression apparatus and a method for suppressing fires based upon the use of a pneumoacoustic atomizer for delivering a mist of water having a droplet size of 50 to 90 microns. Nitrogen from a nitrogen generator is introduced into the structure to reduce the O₂ level to below about 15%. Sensors are provided to activate the fire suppression system when the presence of fire is detected. The sensors may be set to provide maximum water pressure to the nozzle at a preselect temperature and then at a lower pressure when a lower temperature is reached.

US 2004/0188104 discloses an pneumoacoustic atomizer of the type for use in fire suppression such as in the manner described in U.S. Pat. No. 6,390,203.

WO/2005/082545 and WO/2005/082546 disclose improvements in apparatus for generating mists employed for fire suppression. As the applicants point out, a major disadvantage of prior systems is that they require high pressures to produce the mist. With high pressures droplets of less than 50 microns and generally less than 20 microns in size can be produced by employing a nozzle comprising a conduit having a mixing chamber and a transport nozzle in communication with the conduit so that it interacts with the working fluid.

### BRIEF SUMMARY OF THE INVENTION

This invention relates to a process for generating a fire suppressing mist comprising the step of passing deionized water and a fire suppressing gas through a two phase nozzle.

This invention additionally provides a process for suppressing a fire in an enclosed area which comprises the step of: generating a fire suppressing mist comprising finely divided droplets of water and fire suppressing gas and directing said fire suppressing mist into said enclosed area, wherein said water in said generating step is deionized water at a low set temperature T1 and switches to tap water at a temperature T2 which is higher than T1.

This invention further provides a process for suppressing a fire in an enclosed area which comprises the steps of: measuring a temperature T in said enclosed area; comparing said T to a set temperature T1; generating a fire suppressing mist comprising finely divided droplets of water and fire suppressing gas; and directing said fire suppressing mist into said enclosed area, wherein said water in said generating step is deionized water if said T is less than said T1 or said water in said generating step is tap water if said T is greater than said T1.

This invention further provides a process for generating a fire suppressing mist comprising the steps of passing deionized water and a fire suppressing gas through a nozzle; and directing said fire suppressing mist into an enclosed area.

In some embodiments this invention provides that the mist comprising finely divided droplets of water and the fire suppression gas can be at low pressures.

### BRIEF DESCRIPTION OF SEVERAL VIEWS OF THE DRAWINGS

FIG. 1 is a plot of room average oxygen mole fraction vs. time.

FIG. 2 is a plot of flame length vs. time.

FIG. 3 is a plot of droplet size vs. surface area.

FIG. 4 is a plot of droplet size vs. nozzle pressure.

### DETAILED DESCRIPTION OF THE INVENTION

Heretofore, the art has observed that one can more quickly suppress fires within a confined space by introducing a mist having a particle size of from about 5 to 100 microns, preferably from about 10 to 50 microns. Such mists when directed toward the source of the fire vaporize quickly resulting in a dramatic reduction in the partial pressure of oxygen and heat absorption. Oxygen reduction results in a reduction in flame height and reduces its ability to spread to other areas. Traditionally, water sprinklers had been used to extinguish fires, but it has been found that water sprinklers, unless directly focused on the fire itself, merely flood the area without achieving significant fire suppression.

In the initial stage of fire suppression where the fire is small the size of droplets also should be relatively small. Once the average droplet size exceeds about 50 microns, the droplets do not vaporize readily because it is difficult for them to remain air-borne. Such droplets tend to settle on surfaces often causing damage. On the other hand, smaller and colloidally dispersed droplets in the 10 to 30 micron range quickly evaporate, even with the minimal heat generated by a small fire, thereby driving the oxygen concentration downward. The effect of oxygen deprivation in the early stage of the fire helps to prevent the fire from becoming established.

It has been found that if one employs deionized water as the water source for nozzle systems, which may be two phase nozzle systems, suited for generating fine droplets within a range of 5 to 100 microns, and preferably from 10 to 50 microns, one can produce a more uniform droplet size and also reduce the average size of the droplets for a given nozzle pressure than when tap water is used as the water source. (The term “tap water” will be used for the water source commonly used in a fire suppression process and system. The actual source of the tap water may be a well or a storage container, containing a water source other than one comprising deionized water.) Droplet formation in the range of 10 to 50 microns can be produced at pressures of about 5 to 20 psig with the advantages at nozzle pressures of from about 7 to 15 psig. As the delivery pressure is increased above about 20 psig the reduction in the size of the droplets formed from deionized water as compared to tap water begins to disappear.

One of the benefits of the process in terms of addressing an appropriate response to a perceived fire is that one can employ a low temperature fire detector set point T1 and initiate response using deionized water to generate very small water droplets. In the event of a false alarm, the mist remains colloidally dispersed and excess moisture can be evacuated by ventilation systems, minimizing damage to the structure and equipment therein. If the initial response to the fire remains inadequate a second fire detector set point T2 may trigger a switch in the water source to tap water and generate larger droplets. The act of switching the water source automatically increases the size of the water droplets, e.g., from 10 to 30 microns to 50 to 100 microns, in response to the larger fire. Other benefits to the initial spraying of water in the form of a very fine mist into the chamber as the spray have been set forth.

Alternatively, upon detection of a fire, for example by a smoke detector, a temperature in an enclosed area may be measured and compared to a set temperature. Below the set temperature deionized water will be used to generate the fire suppression mist and above the set temperature tap water will be used to generate the fire suppression mist. The temperature measuring and comparing steps may be for this and the previous embodiment may be repeated continuously, semi-continuously, or intermittently during the duration of the fire.

It is common to use a relatively inert (fire suppressing) gas to pressurize the nozzle system employed and generate a finely divided mist comprised of water vapor and inert gas. Often, these inert gases are based upon nitrogen and mixtures of nitrogen with carbon dioxide. Air may be used but it is preferred to employ a gas of lower oxygen content, e.g., a nitrogen rich gas generated via membrane, pressure swing and vacuum swing adsorption processes. In one embodiment the gas that may be mixed with the water is a “breathable gas”, i.e., one that acts as a fire suppressant because of its low oxygen content but contains sufficient oxygen to support life.

A variety of nozzles have been developed for use in generating micron size water droplets in fire suppression systems. A major focus has been in the development of nozzles which can generate finely divided droplets of less than about 50 microns at lower pressure. High delivery pressures to the nozzle can achieve uniformity in droplet size and achieve smaller droplets, but such systems require special equipment. An advantage here is that droplet size reduction can occur at conventional tap water pressures.

Exemplary nozzles for fire suppression include those working nozzles which have angular orientation allowing for interaction and atomization. More specifically, one example of a nozzle for generating a mist comprises a conduit having a mixing chamber and an exit; a transport nozzle in fluid communication with the conduit. The transport nozzle is adapted to introduce water into the mixing chamber. A working nozzle is positioned adjacent the transport nozzle intermediate the transport nozzle and the exit, the working nozzle also being adapted to introduce water or gas as a working fluid into the mixing chamber. The transport and working nozzles having an angular orientation and internal geometry such that in use interaction of the transport fluid, e.g., steam and working fluid, e.g., water, in the mixing chamber causes the working fluid to atomize and form a dispersed vapour/droplet flow regime, which is discharged as a mist from the exit. Such an example and the desirability of delivering finely divided water droplets at low pressure is found in WO/2005/082546 and is incorporated by reference.

A second type of exemplary nozzle for producing small droplets is referred to as a pneumoacoustic atomizer. A fire suppressing gas, e.g., nitrogen or breathable gas, and water are formed into a mist and delivered to the site of the fire.

In two phase nozzle systems, a wide variety of gas to water ratios mass basis) may be used. Mass ratios of from 0.01 to 10:1 and preferably mass ratios from about 0.2 to 1.5:1 gas to water are preferred.

One may add surfactants to the deionized water source (or to a tap water source) to assist in the reduction of droplet size. Furthermore, surfactant addition may afford other advantages and the desirability of incorporation is at the discretion of the design engineer. Examples of surfactants which may be added to the deionized water source include any of the known and conventional surfactants and emulsifying agents known in the art, principally the nonionic, anionic, and cationic materials, heretofore employed in emulsion polymerization. Among the anionic surfactants which may provide good results are sulfosuccinates, alkyl sulfates and ether sulfates, such as sodium lauryl sulfate, sodium octyl sulfate, sodium tridecyl sulfate, and sodium isodecyl sulfate, sulfonates, such as dodecylbenzene sulfonate, alpha olefin sulfonates, and phosphate esters, such as the various linear alcohol phosphate esters, branched alcohol phosphate esters, and alkylphenolphosphate esters.

Examples of suitable nonionic surfactants include Surfynol® acetylenic diols and ethoxylated diols, Igepal surfactants which are members of a series of alkylphenoxypoly(ethyleneoxy)ethanols having alkyl groups containing from about 7 to 18 carbon atoms, and having from about 4 to 100 ethyleneoxy units, such as the octylphenoxy poly(ethyleneoxy)ethanols, nonylphenoxy poly(ethyleneoxy)ethanols, and dodecylphenoxy poly(ethyleneoxy)ethanols. Others include fatty acid amides, fatty acid esters, glycerol esters, and their ethoxylates, ethylene oxide/propylene oxide block polymers, secondary alcohol ethoxylates, and tridecylalcohol ethoxylates. Silicon based surfactants may also be employed.

Surfactants when employed are added to the deionized water in an amount of not more than 5000 ppm. But generally, when it is deemed desirable to add surfactants to form the fire suppressing mist they are added in an amount of from 50 to 300 ppm.

The following examples are provided to illustrate various embodiments of the invention and are not intended to restrict the scope thereof.

### EXAMPLE 1

### Effect of Droplet Size on Fire Suppression

### General Procedure

Fire suppression simulations were carried out based upon a flame having a width of 0.127 meters producing 50,000 BTU's/hour in a room having a dimension of 4 meters in diameter and a height of 3 meters. The simulations were carried out with a commercial general-purpose computational fluid dynamics software package called FLUENT by Fluent, Inc. Fire suppressing sprays were introduced from the ceiling in the room. Assumptions made in the simulations included an axisymmetric model, turbulent flow, oxygen consumption by the fire is insignificant; and a ceiling temperature of 355° F. is reached 76 seconds after the fire has started when no fire suppressing treatments provided. A fire suppressing medium (FSM) of water and gas at a 4.4 lb/minute was used. Droplet size was varied from 25 to 1000 microns.

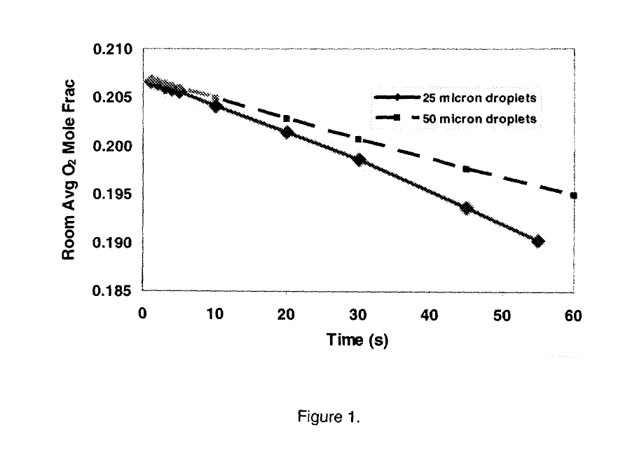

The average molar concentration of oxygen as simulated in the room was determined and is shown in FIG. 1. The results show that the smaller droplets in the range of 25 microns provide a lower oxygen concentration in a shorter amount of time and that oxygen concentration (mole fraction in the room) may be reduced more quickly to a level below that necessary to support combustion, typically 15% mole fraction.

### EXAMPLE 2

### Effect of Droplet Size on Flame Height

The simulation of Example 1 was repeated except that flame height was measured as a function of droplet size.

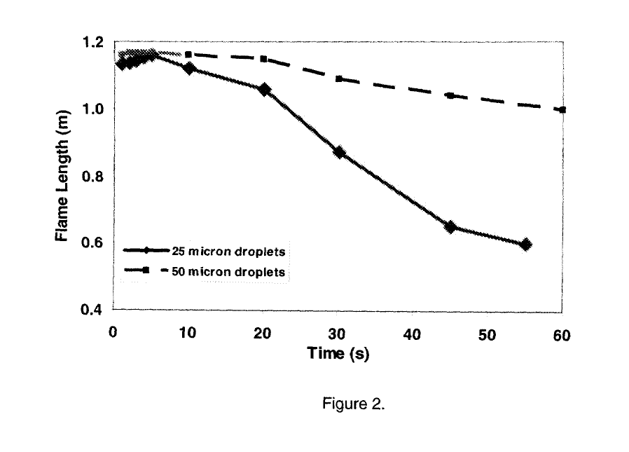

FIG. 2 shows that finer water droplets reduce the flame height faster. As shown in FIG. 2, the flame height of the simulated fire was reduced by a factor 50% in less than a minute using a 25 micron mist.

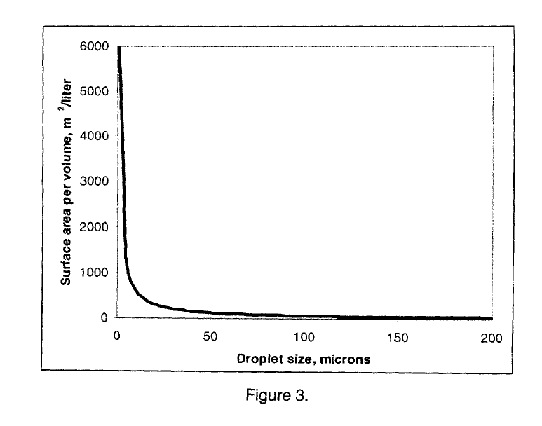

It is believed the effectiveness of the small droplet size in a fire suppressing mist is a result of the increased surface area of the droplet. FIG. 3 is a view of droplet size vs. surface area. As shown in FIG. 3, finer droplets result in more total surface area.

### EXAMPLE 3

### Determination of Effect of Surfactants and Deionized Water on Droplet Size as a Function of Pressure

Several formulations for a fire suppression application were evaluated using air-atomizing and hydraulic style nozzles to determine the effects of atomizing air flow rate, liquid flow rate and composition of the liquid on the drop size and spray characteristics.

The nozzles used during testing were Spraying Systems Co. ¼ JAU-SS Automatic Air Atomizing Nozzles. The JAU style nozzle features an internal air cylinder for controlled “on-off” operation up to 180 cycles per minute. A wide variety of spray set-ups can be used with this nozzle to create a variety of flat and round spray patterns. This nozzle can also be equipped with a clean-out needle that protrudes through the liquid orifice on every cycle.

The ¼ JAU-SS nozzle provides identical spray performance to the ¼J nozzle. However, the automated features of the ¼ JAU allow for quicker testing trials. These nozzles use an atomizing gas stream to bombard the liquid stream, breaking up the liquid stream into fine droplets. The compact design is specially designed to provide uniform distribution of small droplets. These nozzles are internal mix, air atomizing style nozzles. These nozzles provide a round spray pattern with small to medium drop size distribution.

Additionally a ¼ LN-1 nozzle was used for comparison purposes. This nozzle provides a very finely atomized spray in a semi-hollow cone spray pattern. These nozzles use liquid pressure to provide the energy to break up the liquid into fine droplets.

An AutoJet® 2-Channel Modular Spray System was used to control the operation of the spray gun as well as to control the liquid and air pressures. The AutoJet® Modular Spray System is a self-contained, modular spraying system that enhances the performance of automatic spray guns. Consisting of two basic components, an electrical control panel and a pneumatic control panel, the modular system provides the power of a fully integrated system. This system was set up so that the two nozzles could be controlled completely independently from one another. From small dots to a smooth, uniform coating, the AutoJet Modular Spray System provides excellent spray gun control with dependable results.

### Drop Size Measurement

For drop sizing, the nozzles were mounted on a 3-axis traverse. A clamp assembly held the nozzle in place and the spray distance was held at a height of 6 inches. Drop size testing was performed in the center of the spray throughout. Additional analysis was performed at ten locations, based on nozzle performance, at 15 mm increments from the center of the spray towards the edge.

A two-dimensional TSI/Aerometrics PDPA instrument was used to make drop size and velocity measurements. A 300-mWatt Argon-Ion laser provided the light source. The laser was operated at an adequate power setting to offset any dense spray effects. The transmitter and receiver were mounted on a rail assembly with rotary plates; a 40° forward scatter collection angle was used. For this particular test, the choice of lenses was 250-mm for the transmitter and 500-mm for the receiver unit. This resulted in a size range with a size of about 0.5 μm-236 μm for water drops. This optical setup was used to ensure capturing the full range of droplet sizes while maintaining good measurement resolution.

Table 1 shows the test setup and the drop size results. The size was measured at 6 inches away from the nozzle. Nozzles ¼JAU-SU11 and ¼ LN-1 were used. The ¼ JAU-SU11 nozzle was capable of an air-to-water mass ratio of 0.14 to 0.67. The droplet size characterized in Sauter Mean diameters are reported in microns.

TABLE 1
Test conditions, droplet size results and test number

| | | Two-phase | | |
|---|---|---|---|---|
| | | ¼ | water jet | |
| | | JAU-SU11 | ¼LN-1 | |
| | | 10 psig | 150 psig | |
| | | 11 psig | NA | |
| | Water pressure | Dia | Dia | Test |
| | Air pressure | (microns) | (microns) | number |
| 1 | control tap water | 38.3 | 50.8 | |
| 2 | Dynol ™ 604 surfactant | 34.6 | 49.9 | 77b |
| | 125 ppm in tap water | | | |
| 3 | Dynol ™ 604 surfactant | 37.2 | 52 | 77h |
| | 300 ppm in tap water | | | |
| 4 | Dynol ™ 604 surfactant | 23.4 | 50.1 | 77i |
| | 300 ppm in deionized water | | | |
| 5 | Surfynol ® 2502 surfactant | 33.9 | 47.2 | 77f |
| | 625 ppm in tap water | | | |
| 6 | Surfynol ® 2502 surfactant | 35.9 | 48.4 | 77e |
| | 2500 ppm in tap water | | | |

Note:
Dynol ™ 604 surfactant is an ethoxylated acetylenic diol and Surfynol ® 2502 surfactant is an ethoxylated acetylenic diol endcapped with propylene oxide. Both Dynol ™ and Surfynol ® surfactants are commercially available from Air Products and Chemicals, Inc.

The results in Table 1 show that the addition of the surfactants to water affords modest improvement in droplet size when an air/water mix is sprayed from the 2 phase nozzle. The maximum drop size reduction for each surfactant tested was about 10%. On the other hand, the mixture of Dynol™ 604 surfactant in deionized water resulted in a significant reduction (39%) in the size of droplets when sprayed from the 2 phase nozzle. Additionally a more uniform spray pattern resulted (the range of droplet diameters reduced from 32-73 microns to 21-34 microns). In view of the fact that Dynol™ 604 surfactant dispersed in tap water afforded little change in droplet size, the reduction in droplet size from the two phase nozzle is attributed largely to the water source.

The influence of a deionized water source as compared to a tap water source is reduced in the single phase water jet system as opposed to the results obtained with the two phase nozzle system.

### EXAMPLE 4

### Effect of Delivery Pressures on Droplet Size

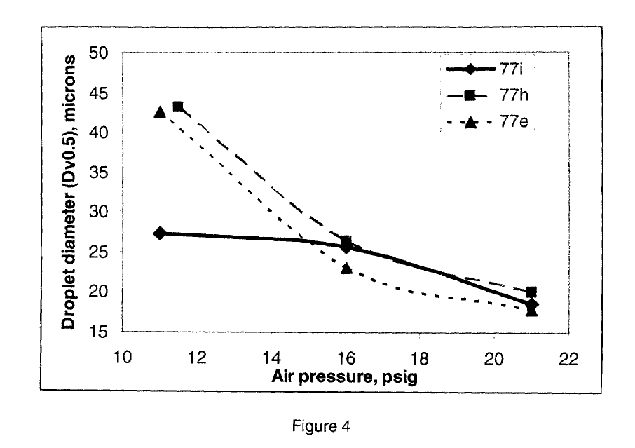

In view of the results in Example 3 the effect of droplet size as a function of air pressure was determined. It was desired to determine if droplet size reduction could be maintained over various air pressures. The liquid pressure was fixed at 10 psig. Gas to water mass ratios between 0.14-0.67 were used. The results were plotted in FIG. 4. It can be observed from FIG. 4 that as the air pressure increased the amount of reduction in the average size of the droplets decreased. The significant finding is that a reduction in droplet size can occur at low air pressures when using water at municipal delivery pressure levels e.g. water pressures of 5 to 15 psig and when using deionized water. Thus, one can pass municipal water through a deionizer in the initial stage of a fire and effect fire suppression with small droplets of deionized water using a 2-phase nozzle and a fire suppression gas at low pressure, and if necessary and desired then switch to municipal or tap water at higher flow rates at a later stage of the fire and effect fire suppression with larger water droplets.

1. A process for generating a fire suppressing mist comprising the step of passing deionized water and a fire suppressing gas through a two phase nozzle.

2. The process of claim 1 wherein the diameter of the finely divided water droplets formed is in the range of from 5 to 100 microns.

3. The process of claim 2 wherein the diameter of the water droplets is in the range of from 10 to 50 microns.

4. The process of claim 3 wherein the water is passed through said nozzle at a pressure of from 5 to 15 psig.

5. The process of claim 1 wherein the fire suppressing mist comprises of deionized water, surfactant, and said fire suppressing gas.

6. The process of claim 5 where the surfactant concentration in the fire suppressing mist is not more than 5000 ppm.

7. The process of claim 6 wherein the surfactant concentration is from 50 to 300 ppm.

8. The process of claim 1 wherein the mass ratio of fire suppressing gas to deionized water in said fire suppressing mist is from 0.01 to 10:1.

9. The process of claim 8 wherein the mass ratio of fire suppressing gas to deionized water in said fire suppressing mist is from 0.2 to 1.5:1.

10. A process for suppressing a fire in an enclosed area which comprises the step of: generating a fire suppressing mist comprising finely divided droplets of water and fire suppressing gas and directing said fire suppressing mist into said enclosed area, wherein said water in said generating step is deionized water at a low set temperature T1 and switches to tap water at a temperature T2 which is higher than T1.

11. The process of claim 10 wherein the fire suppressing mist is generated in a two phase nozzle system.

12. The process of claim 11 wherein the fire suppressing gas is comprised of nitrogen and oxygen wherein the oxygen concentration is below an amount necessary for supporting combustion.

13. The process of claim 12 wherein the fire suppressing gas is a breathable gas.

14. A process for generating a fire suppressing mist comprising the steps of passing deionized water and a fire suppressing gas through a nozzle; and directing said fire suppressing mist into an enclosed area.

15. The process of claim 14 wherein the mass ratio of fire suppressing gas to water is from 0.2 to 1.5:1.

16. The process of claim 14 wherein a surfactant in an amount not more than 5000 ppm by weight of said deionized water is added to the fire suppressing mist.

17. The process of claim 16 wherein the surfactant is selected from the group consisting of silicone and acetylenic diol surfactants.

18. The process of claim 17 wherein the surfactant is an ethoxylated acetylenic diol.

19. A process for suppressing a fire in an enclosed area which comprises the steps of: measuring a temperature T in said enclosed area; comparing said T to a set temperature T1, and generating a fire suppressing mist comprising finely divided droplets of water and fire suppressing gas and directing said fire suppressing mist into said enclosed area, wherein said water in said generating step is deionized water if T is less than said set temperature T1 and is tap water if said temperature is greater than T1.
